(19) United States
(12) Patent Application Publication
(10) Pub. No.: US 2008/0126126 A1
(43) Pub. Date: May 29, 2008

(54) Method And Apparatus For Managing And Locating Hospital Assets, Patients And Personnel

(76) Inventor: Phil Ballai, High Bridge, NJ (US)

Correspondence Address: GIBBONS P.C., ONE GATEWAY CENTER, NEWARK, NJ, 07102, US

(21) Appl. No.: 11/938,089

(22) Filed: Nov. 9, 2007

Related U.S. Application Data
(60) Provisional application No. 60/858,669, filed on Nov. 13, 2006.

(51) Int. Cl. G06Q 50/00; H04Q 5/22

(52) U.S. Cl. 705/2; 340/5.2; 340/10.42

(57) ABSTRACT

An apparatus and method for facilitating locating, tracking and managing of hospital assets, patients and hospital personnel within a healthcare facility, providing one or more signal detecting devices configured in locations within a healthcare facility, providing associated patient RFID tags which may be sensed as the patient moves within the range of a signal detecting device, where one or more zones of detection within the healthcare facility are configured to correspond with hospital units, and where the information may be collected and used in real-time to manage patients, assets and staff through the collection of location and dwell times, and alerting and reporting of events associated with the collected information.

### CROSS REFERENCE TO RELATED APPLICATIONS

This application claims priority to U.S. provisional application Ser. No. 60/858,669, filed on Nov. 13, 2006, the complete disclosure of which is incorporated herein by reference.

### BACKGROUND OF THE INVENTION

The invention relates to hospital resource management, and more particularly to apparatus and methods for maintaining hospital assets, patients and personnel.

Hospitals have a large number of ongoing activities taking place in order to maintain the operations of the hospital. One activity involves hospital staffing. Staffing of doctors, nurses and other staff is essential for the hospital operations to be sustained. The patients must be supported by the hospital personnel and equipment. It also is important to keep track of patients and the rooms, and the number of beds a hospital is using as well as the number of beds a hospital has available. This, however, is often difficult, and with patients coming in, and other patients being discharged, often, there is not an account of the number of beds available. In many cases, hospitals may underreport through their internal procedures the number of available beds. Since the hospital revenues may be related to bed utilization, any available beds which are not accounted for may result in lost revenues for the hospital. Similarly, where overcrowding occurs because of the converse, where a hospital believes it has a larger number of available beds than it actually does, then this may lead to other problems, including overcrowding, patient neglect, harm to the hospital's reputation, as well as potential violations of standards and codes. When patients are admitted to a hospital, it is important to keep track of the patient, as the patient moves, or is moved, about the care facility. Patients are generally assigned a room, but if a patient strays from the room, or is transported to another location within the care facility, that patient may be “lost” or unaccounted for.

Hospitals utilize a number of staff for different purposes. In the operating room, there may be staffs of operating room nurses, surgeons, and others who assist with facilitating equipment or personnel for surgical procedures. On a patient floor of a hospital, staffing is required to meet certain levels to provide adequate care for the patients housed there. A cardiac care floor or unit of a floor may have different staffing requirements from a pediatric floor or unit. The staffing pools may be different. There may be a need for a particular type of physician to always be on a floor, or a minimum number of nurses or other staff to be present.

A “white board” is used throughout many hospitals to record patient information, including the patient room, physician, and other particular information. With the HIPPA and other privacy concerns, the white board may be limited in the type of information, or positioning of the location of the board. The “white board” is generally maintained at a station on the floor or unit where the staff workstations are located.

Hospitals also invest heavily in equipment. Hospitals must purchase and maintain equipment to perform contemporary testing procedures, scans, and analyses for patients, as well as advanced surgical procedures. In some cases, all or part of the equipment is disposable, and may not be reused. In other cases, equipment may be reusable. Often, hospital equipment is very costly, and therefore, the high equipment cost may require that the hospital permit one or more or all units or floors to share certain types of equipment. For example, an ultrasound unit may be capable of being used on one or more floors or hospital units (e.g., gynecology and radiology). Equipment in some instances may be taken from one location in a hospital to another. Often, equipment remains at the location of the facility at which it was last used. In some instances, hospitals place markings on the equipment, such as with pen or ink, designating a location, such as a unit or floor, e.g., “radiology”.

For example, where a patient is transported in a wheelchair to a fitness center of a hospital to receive therapy, the wheelchair may be left at the fitness center location. The patient may be returned to that patient's room by another attendant, who has obtained a wheelchair from another location. Another example is that patient discharges from a hospital may be from one or more exit locations. If the patient is discharged using a wheelchair, that chair is likely to remain at one of the discharge exit locations.

A need exists for a method and apparatus which facilitates the location and management of hospital assets, as well as patients and even hospital staffing, in order to improve efficiencies throughout the care facility.

### BRIEF SUMMARY OF THE INVENTION

A method and apparatus for locating, tracking and managing hospital assets, patients and hospital personnel is provided. According to one embodiment, the method and apparatus coordinate asset utilization by tracking asset location. According to one or more embodiments, asset availability also may be tracked, as may asset usage. The asset utilization information may be made available in real-time. The method and apparatus facilitate patient management by providing the ability for real-time tracking of patients within a hospital facility. Hospital staffing may be facilitated through coordinating the staffing personnel, such as, for example, by type, number and location, with hospital needs or individual patient needs. The method and apparatus may be used to improve hospital utilization of assets and/or personnel to facilitate improved patient care as well as cost economies.

Embodiments of the method and apparatus facilitate patient discharge management and patient tracking in a healthcare facility. For example, patient admission and information systems may be integrated with the other systems of the healthcare facility. According to one embodiment of the invention, patient bed assignments may be scheduled or reserved, patient transfers and assignments may be more readily carried out using on-demand bed availability information.

According to embodiments, the use of wireless infrastructure may be employed, or alternately, or in conjunction therewith, wireless electronic transmission and detection equipment may be utilized, to facilitate the management, locating and utilization of patients, personnel beds, and other hospital assets. Active management of RFID devices may be used to facilitate area, personnel or patient types through configuration of location, detection responses and generation and perception of events.

According to embodiments, active RFID devices may be used with a care facility's existing infrastructure, such as for example existing WiFi, to facilitate tracking and locating of patients throughout a care facility stay or visit, or an emergency department process, as well as tracking and locating assets and/or personnel.

According to embodiments, the method and apparatus may provide true location, alerts, updates and information in a manner that conserves or minimizes time required by the staff.

### BRIEF DESCRIPTION OF THE DRAWINGS

FIG. 1 is an illustration of a display in accordance with an embodiment of the invention showing an example of patient tracking in connection with the monitoring of a waiting room of a radiology unit at a hospital.

FIG. 2 is a schematic diagram illustrating a patient room and waiting room in accordance with an embodiment of the invention.

FIG. 3 is a flow diagram illustrating an example of an embodiment of a method according to the invention.

### DETAILED DESCRIPTION OF THE INVENTION

A method and apparatus for locating, tracking and managing hospital assets, patients and hospital personnel is provided. According to one embodiment, a patient tracking engine (PTE) may be provided for facilitating locating a patient within the hospital facility (i.e., care facility). The patient tracking engine (PTE) may include software programmed with a set of instructions for retrieving, identifying and associating patient information with one or more hospital assets or locations. The patient information may be input into a database, such as, for example, a patient management database. A main screen may be generated on a display. The patient tracking engine (PTE) may be used in conjunction with a computer with an input device, such as, for example a keyboard, scanner, or microphone, and a display means for viewing the information, such as a monitor, PDA or other device. A patient management engine (PME) may be provided to facilitate management of a patient within the care facility. According to one embodiment, the PME may be associated with the PTE, while in other embodiments the PME may be provided as a component of the PTE. The patient tracking engine (PTE) may be configured having levels of access, so that personnel of a particular designated level or levels may access the patient management engine. Within the patient management engine (PME) there also may be configured sub levels. For example, an administrator level may be required to add a patient. A screen display may be generated by the patient management engine (PME) affording personnel the ability to input a log in, such as, for example, by using a user name and password. An input screen may be generated or selected to generate on a display, and information may be input by the authorized personnel. A patient record may be added, including patient information, such as, for example, the location, time of entry or admission, patient name, physician, nurse, along with other fields, including even a comment field. Patient information may be stored within the patient database, or another database linked with, or accessible to, the PTE and/or PME. For example, a returning patient may be included and may be selected through a menu or search for patients. The PME may be programmed to search a database known to have patient information, and may determine whether there exists one or more potential matches. Patient information may be entered in accordance with inputs requested on a screen display. The PME may generate required fields where input is to be received. For example, patient social security number, date of birth, name, address, are examples of some of the fields which may be included. The PME may be configured to save patient input data to a data file such as, for example, a database. An account number may be assigned or generated for the patient. The PME may be configured to require certain information in order to accept the entry of a new patient or to continue to process an existing patient. For example, a patient account number, first name and last name may be required fields of input.

The PME may also be programmed to associate a patient with a tag. A tag, for example, may be an RF tag capable of responding to or generating an energy frequency which may be sensed by a corresponding associated sensing device. The tag may be provided with identifying indicia, such as, for example, a serial number, bar code, mac address, or other number or alphanumeric designation. The identification indicia may include unique information in order to distinguish patients (or assets or personnel, as the case may be, depending on whom or on what the tag is located or associated). The bar code or other indicia is associated with the unique identification (a frequency or mac address, for example) so that a response associated with the tag may be identified to correspond with the person or asset to whom the tag has been assigned. In addition, according to one or more embodiments, tags, in addition to a unique identifier, may have one or more other identifiers, such as, for example, to distinguish certain tag types from others, (e.g., tag types indicative of a patient tag versus staff tag or asset tag). A bar code on or associated with a tag may be scanned with a scanning device which is operatively connected with computing equipment to provide inputs which may be received, processed and used by the PME. A patient field on the display may include a tag field which may be generated to display with the patient information. A tag may be assigned to a patient. For example, a user who is authorized to associate the tag may select a tab or button appearing on a display labeled “Tags” to access that patient's tag information. A tag is associated with the patient by inputting the tag indicia. This may be accomplished using a barcode scanner, or alternately, by typing a code corresponding with the tag into a textbox and entering that information so it is received by the PME. The tag may be entered with the initial information of the patient, so that when the patient is first identified within the facility, the tag may be associated and distributed.

The PME also provides data for the patient by including a field, which may be the tag field, which informs with an alert in the event a patient already has a tag associated with that patient. For example, if a patient already has a tag assigned to him/her, the information may be generated to appear in a “current tag” field. According to one embodiment, in this case, the button on the display which enables the assignment of a tag may provide an option to unassign the tag to allow removal of the association between the tag and the patient.

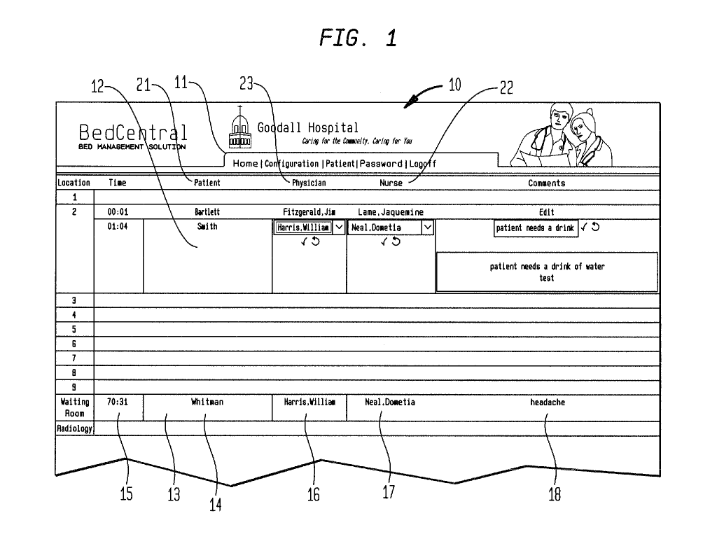

The patient management engine (PME) may be programmed to provide information relating to the location of a patient within the facility. A patient location module may be configured to provide one or more location zones within a facility and then assess the location of patients relative to the zones. For example, FIG. 1 illustrates an example of a screen display 10 having a menu tab “home” 11 which may cause to be displayed a real-time, live animated display featuring the patient identification and the location zone corresponding to the location of the patient. According to one embodiment, the patient tag is sensed by an exciter or detector and the PME associates the exciter or detector identification with a corresponding location based on the stored associated location information for the detector/exciter. An alert may be generated on the display to correspond with a patient name or field. For example, the PME may be configured to display a flashing green color over a patient name or field row, as illustrated in the shaded area 12 in FIG. 1 when a condition or threshold has been sensed. For example, flashing green shading over a patient name on the display may be used to indicate that the respective patient is in a specific location past the dwell timeout value of this location. For example, in FIG. 1 an event is provided for a patient who needs a drink of water. Another example would be where the PME is configured to display a flashing red area 13 over a patient's name 14 or one or more (or all) fields 15, 16, 17, 18 to indicate that the patient has “eloped” or left the department or unit through the doorway. For example, as shown in FIG. 1, the patient Whitman is indicated to have left the waiting room in which the patient was previously detected to have occupied. Other possible colors, shading, and effects may be utilized to generate alerts or designate conditions. The alert or condition may be generated in response to designated or perceived events (e.g., sensed by detecting devices). Time records may be displayed and stored to provide an indication or record of locations where the patient has been, the duration there, as well as the dwell time in a single location where the patient may currently be.

The PME may be programmed to provide a comment field associated with a patient so that comments may be entered, stored and retrieved for viewing by doctors, nurses and other authorized personnel. An editing feature may be used to permit access to the fields to change doctor, nurse or comment information. The PME may be programmed so that the display of patient information displays the last entered comment first. Comment information may be stored by time and date of comment and with an indicator or identifier of the person making the comment. When a comment is input, the user (who is authorized to access, make or revise the comment) may have the ability to determine whether the comment should be saved. For example, indicia such as a check mark may be used as a selection button to save a comment, and a curved arrow, a selection to undo the changes.

The method and apparatus facilitates automation of patient flow in a healthcare facility including from patient arrival at the facility to patient discharge. Analytical evaluation may be coordinated with the information obtained relating to patient locations to facilitate logistics and protocols in a healthcare facility. The method and apparatus also aid to minimize losses due to failure to keep track of patients and rooms, such as, for example, where meals (not needed) are delivered to vacated rooms or rooms of transferred patients. These losses may be even more costly where pharmacy costs are involved, where medication is delivered to a vacated patient room (as often dispensed medication may not be reused or stored). The method and apparatus may conserve time in determining bed type and availability. By being able to have knowledge of the locations of patients, room availability information may be facilitated. This may reduce the number of patients who may otherwise leave an emergency room because of lengthy waits to admissions because of a lack of information as to bed availability. Similarly, the patient management engine (PME) may facilitate the improvement of patient bed occupancy.

The apparatus for locating and managing hospital assets, patients and personnel may include a processor operatively configured with a storage component. The processor may be provided in the form of a server and the storage component may include a hard drive which may be part of the server or may be separate from the server. According to some embodiments, the storage device is accessible by one or more computers at the care facility (including, for example, servers, desktop units and/or PDA's). Software may be installed on the server and the software may include instructions for carrying out the retrieval, storage, comparison, identification, and other processes performed in conjunction with the management of patient, asset and personnel locations.

A communications network may be established to facilitate communications between devices on the network, including those devices which detect, broadcast or relay information. For example, according to some embodiments, a plurality of exciters may be placed at locations throughout the hospital facility to correspond with zones which are to be defined as locations. The exciters may generate a ringing frequency to ring the RF circuitry, in the case of an RF tag. Detectors may be positioned to detect within certain areas or zones. The detectors are linked with the network so that the response from a detector may be obtained and processed. The detectors may be configured to correspond with or be associated with one or more locations of a hospital. One or more detectors (e.g., a group of detectors) may detect for the same location, such as, for example, where the geometry of the space to be detected requires more than one, or where the area is correspondingly large. A detector may include sensing circuitry to sense an energy or signal field, such as, for example, an RF field, and may optionally include a generator for generating a signal to ring a tag (which may have associated circuitry). According to one or more embodiments, detectors and exciters may be separately provided.

A wired or wireless network may be used to allow communication of the stationary components. An existing infrastructure network may be used, such as a hospital's existing WiFi network. Alternately, or in conjunction with the existing network, separate network components may be used, and may be configured to eliminate or minimize interference with existing networks or equipment. In addition to a computer, such as a server, display devices, such as, for example, monitors are used for displaying the information.

According to embodiments, a “whiteboard” display may be provided at a nurse's station of a unit or floor. The “whiteboard” display may comprise a monitor, such as an LCD or plasma screen, or a projector. Software may be used to generate a visual display. The visual display may consist of a single browser screen, and may be generated for display on a high quality LCD or plasma monitor. For example, a size for use at a nurses' station may be 37″ or 42″. The information may be displayed on the monitor so that a number of lines may be displayed which may be readable at customary distances. The “whiteboard” display may be operative with the PTE and/or PME to display information.

In addition to the whiteboard display, other displays may be provided, alternately or in conjunction therewith, including a plurality of monitors which are configured with a workstation or other means for inputting and viewing information.

According to one embodiment, at least one exciter is placed in each patient room and at other locations determined to be of significance, such as, for example, those locations which patients are able to access (whether authorized or not) where assets are located, and where the hospital staff may access. Each exciter may be configured to send an event to a data management engine (DME). The DME may record and store detector/exciter responses and tag identification and location data. The DME may record the information to a database, and/or may communicate the information to the PTE and/or PME. The event used, for example, may be an e-mail alert which contains information. One example of information is referred to below in connection with an event type which is a call button event: [with explanations of the event being provided in square brackets]
Visitor 7 Needs HELP [which is also the subject line]
Event: ‘Visitor 7 Pushed, Call button event’
Timestamp: 07/19/2006 08:50:30
Asset: Visitor 7(MAC: 00-0C-CC-5C-41-62), Push button
Location: ‘All\InfoLogix Corporate’ [This may correspond with the exciter name]
Conditions: ‘Visitor 7 Pushed-Visitor 7-payload=‘HELP62” [This would correspond with the exciter number]
Message: Visitor #7 pushed the call button
   The call button event illustrated represents one type of event. Other events are possible. For example, according to some embodiments a Zone Entry event may be generated for any tag that is not at an exciter. According to one embodiment, tags that are not, or are not paired with, an exciter may generate an ‘Entry’ event when entering a zone. The method and apparatus also may be utilized with “next generation type” tags which include an exciter feature which may accompany a tag, but which may be suppressed. According to one or more embodiments, the tag exciter may be used to generate a particular alert, which may be managed separate from or together with the PME and/or PTE.

Tags may be identified and rendered a status of active or inactive. Since there is the possibility that tags no longer in use or not yet used may generate or respond to exciters or detection equipment, these tags are maintained in a separate location, or may be identified and designated inactive within the PME or other engines or modules. A dwell time event may be commenced upon a tag entering a zone which has an exciter. For example, in the radiology unit, a Radiology exciter may be deployed to provide coverage for that zone. A dwell time event may be established, such as, for example, the generation of an alert if a maximum time threshold (max_time) is exceeded. This may be the dwell time event in HT or a newly created event in the data management engine DME.

The method and apparatus may be applied to track the patient movement within a facility. For example, considering the example shown in FIG. 1, a display is illustrated showing patient location information. “Location” is a dynamic column. Rooms 1-9 are displayed as 1-9. There is also “Radiology” and “Waiting Room”. Other rooms, such as, for example, a restroom., may also be included. Multiple patients could be ‘in’ a room. The PME may be programmed with instructions to generate an indication when this occurs. According to some embodiments, a patient is considered to remain ‘in’ the room until the patient is either 1) in another room or 2) discharged from the care facility. In some cases, there may be separate database indicators for one part of a care facility. For example, where an emergency room is managed separately from the remainder of the care facility, a patient who crosses from the care facility to the emergency room may be treated as discharged, or may be given temporary leave status. According to one embodiment, where a patient in one care facility (or even another care facility not associated with the transferring facility) is transferred for surgery to another location of the care facility (or different facility) which utilizes no, or a different, tracking apparatus ormanaged separate from or together with the PME and/or PTE. configuration, that patient may be shown to be at an alternate location, as opposed to being discharged, eloped or “lost”. For example the PME may be configured to provide a display of a column divided to display the two Zones; “Waiting Room”, WR, and “Emergency Room”, ER. These two areas may be likely to have a random number of people in them and may be displayed in time sequence. The ER may be listed first, and then the WR. A time column may be included to show the time displayed in military or conventional format with a “:”. According to some embodiments, the PME may be programmed to post the time as of the time the tag was assigned to the patient at registration and remain static until the patient is discharged from the care facility. Referring to FIG. 1, a patient name column is also shown. The “Patient” column 21 is illustrated, for example, as a field including the first ten characters of the patient's last name and may be supplied at the time of registration. According to some embodiments, this may be a manual entry. According to alternate embodiments, this field may be supplied by HL7 from an EDIS platform. A nurse column 22 is also shown. The nurse column “Nurse” provides a field for recording the attending nurse's name. The name, for example, may be limited to eight characters, and may be a variable field with the nurse choosing his or her name from a drop down list box. A doctor column 23 is also illustrated. The doctor column 23, “Physician”, provides a field for recording the attending doctor's name. The name may be limited to ten characters, and may be a variable field with the doctor choosing his or her name from a drop down list box. Alternately, other characters including types and numbers may be utilized for association with the nurse or doctor name, such as, for example, an alphanumeric string. A password also may be utilized so that the nurse or doctor is authenticated in order to access the data and features of the system, or one or more levels of information provided by or reported with the system.

A patient having a tag on his or her person may be tracked as the patient moves about the hospital facility. The display may include a column reading ‘Rad’ for radiology, or “x-ray”, or some other indicator associated with the radiology unit and its location within the facility. The PME and the display also provide the ability to ascertain patient room assignment information even when the patient is not in the room. For example, this may be done by clicking on the patient name field or may even be animated to appear (e.g., as an overlay) when an input is received such as moving a cursor, stylus, finger, or the like over the “Location” field for that patient. An exciter may be situated at the entrance to a unit. For example, patients that cross the exciter location leading to a radiology unit may be designated by placement of an indicator in the column corresponding to “Rad” or “x-ray” (or the designation used). The PMF or PTE may be configured so that the patient will not be taken out of the “room” in which the patient has been assigned (even where the patient has been transported to radiology, for example). A dwell monitoring engine (DWE) may include software programmed with instructions for recording the time of entrance into a location, such as, for example, radiology. The DWE may be programmed to generate and report alerts when a threshold dwell time value (dwell_time_max) has been reached. According to one embodiment, the time value threshold may be set either by utilizing an HT Dwell function or internal to the HTD, and may generate a response that may be identified and/or processed to generate an alert, such as, for example, ‘blink’ the indicator on a display, if the ‘max’ time is exceeded. For example, the max time (dwell_time_max) may be configurable either in HT or the HTD.

A comment column may be included. The comment column may provide an area for a caregiver or other personnel, such as a nurse and/or doctor, to make notes on a patient. Where a network of stations is employed, this may be done through the HTD screen display using an input device at any workstation on the network. According to one embodiment, the comments may be entered at registration or at a workstation proximate to the location where nurses and doctors assign or are assigned patients. According to other embodiments, a mobile cart may be used.

An elopement alerting system (EAS) may be utilized to track and generate alerts when patients leave the facility (or a unit within the facility) without being discharged. The term elopement may be used to designate a condition where patients “leave” the facility without being discharged. An elopement indicator may be used, such as, for example, by providing designation of the condition on a display. For example, according to one embodiment, in the case of elopement, the entire patient field (e.g., such as the line or lines visible on the display) corresponding to the eloped patient may be designated to be set to ‘blinking’ (or to a particular color shading, or both, for example). Other alerts also may be used alone or together, such as, for example, audible alerts, sending a page or email, or the like. One or more exciters may be deployed at all points of exit from the facility, and from the timer set, for example, the time recorded when a patient is sent to radiology. The PME may store time and location values of patients within the care facility. The PME may include a reporting engine configured to analyze and manage data from the DME. For example, time of wait for patients undergoing a radiology procedure may be evaluated. The elopement management engine (EME) may include software and may be programmed to detect elopement of a patient (e.g., through responses and signals obtained from detectors). According to one embodiment, if a patient detected as eloping was previously in the emergency room (ER) or WR, then they will be promoted on the list of patients to insure they are displayed on the “white board” screen, or other display. Additionally, or optionally, though described herein as a line being set to blink, one or more alternate or additional alerts, such as pop-ups, pages or text messages, and the like, may be issued either directly from HT or internally from the HTD to provide an alert to one or more staff (or other engines) as to a patient's location or dwell condition.

The apparatus and method may be expanded, so that as a care facility expands, for example, by taking on additional space, building a new wing, or the like, the tag devices may be used, and one or more additional detection devices, such as, for example, exciters, detectors, access points, and the like, may be installed and configured to relay information to the data collection engine or engines.

In addition, where patients are transferred from one care facility to another a share management engine (SME) may be used to relay particular selected or designated patient information, so that the transferee care facility may use that information. This facilitates patient care, especially where the patient is emergently transferred. A transfer alert may be generated. A transfer alert also may be generated to the patient's physician, so that an emergent transfer event for the patient is communicated to the patient's physician (or assigned caregiver). This may enable the physician to provide valuable treatment or historic input, or simply, be used to manage physician appointments for that patient.

The data collection may be used to analyze metrics in order to increase productivity. For example, ambulance drive-bys, due to a lack of indication of available space, may be reduced. The information collected also may be used for staffing and personnel decisions. A reporting engine may generate reports using the collected data.

According to some embodiments, the tags may be WiFi enabled RFID tags. The number of patients and the respective location of patients in one or more areas or zones of the facility may be determined. The RFID tags are associated with respective patients of the facility. Detection apparatus is positioned in one or more locations throughout the hospital facility to receive transmissions from RFID devices. The transmissions are processed with a processing device, such as a computer, and may be stored. Software may be used to provide a set of instructions for handling the information received from the RFID tags. According to some embodiments, the software is included as part of the PME. For example, information that is received from the RF tags may include at which location in the facility the RFID detection is located. This may be ascertained based on the detection apparatus location which senses the RFID in its vicinity. Detection apparatus may be associated with one or more zones within the establishment. Detection apparatus is known by serial number or other assigned designation to identify that unique detector or group of one or more detectors, and associate those one or more detectors with a designated zone of the facility. The designated zone may be a waiting room, a patient room, a cafeteria, the cardiac care unit, the radiology lab, or another desired location. For example, a single detector or group of detectors may define a zone, the zone being within the range of the single detector, or group of detectors. Alternately, or in addition thereto, different detectors (or different groups of detectors) may define different zones. The detection apparatus may receive transmissions from patient associated RFID tags to determine the number of patients in a particular zone of the facility. The location information may also be used for patient management. Another example is where the dwell time for patients in a particular area (a zone) reaches a certain threshold, then this information may be used to generate an alert, such as for example, that more staffing is required or that no additional patients should be brought to the location. An alert may include a management instruction directing one or more conditions or actions to be carried out.

If, for example, a back log of patients is identified in the MRI scanning unit, then this may be used to indicate that the room is at capacity, and may provide an alert to hospital personnel that no further additional patients should be brought to the MRI unit. The PME may also be programmed to perform a needs analysis based on patient data. An optional data field may include the immediacy requirement for tests, such as for example, an MRI scan. This permits regulation of overcrowding based on a needs assessment model. Alternately, according to one embodiment, the alerting of a capacity of patients in an area, such as, for example, the blood lab unit, may signal a need for additional staffing. The staffing management engine (SME) may be coordinated to alert potential hospital staff members who are actively capable of providing assistance that they are needed at the blood lab. The SME may even transmit an instruction for a particular staff member to report to a particular location.

The method and apparatus permit a medical facility, such as a hospital, to dynamically maintain patient locating and management as well as hospital staffing and equipment and asset management. In addition, the method and apparatus may provide an analysis engine to create ‘surge’ models, evaluate trends based on time of day, year, or events, and provide better service to the patients using the facility.

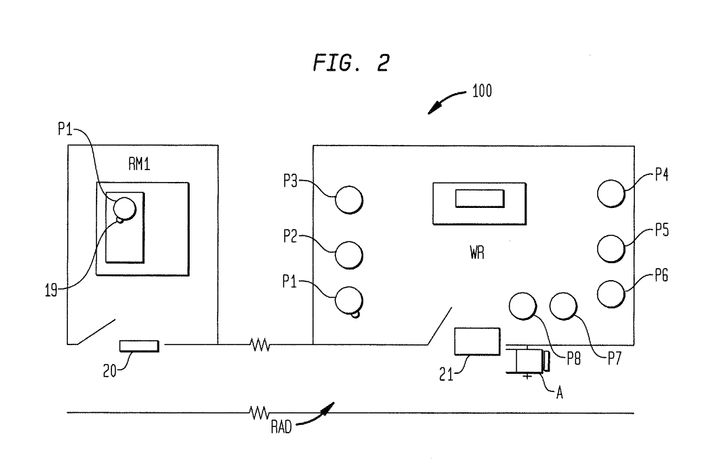

An example illustrating an embodiment of the invention is shown in FIG. 2 as a schematic diagram illustrating one embodiment of the method and apparatus for monitoring a waiting room WR of a radiology unit RAD at a hospital, and alerting one or more staff members when a condition, such as, the number and/or dwell time of patients P1 through P8 waiting in the waiting room (the waiting room zone) exceeds a threshold. The patient P1 (represented by a broken-line circle) is shown in the patient room RM1. The patient P1 has a patient tag 19 which is detected by the detection device 20 shown at the entrance of the patient room RM1. As the patient P1 exits patient room RM1, the detection device 20 senses that and records that data or event (or fails to continue to detect the patient P1 in the RM1). The patient P1 moves through the facility 100 to the radiology unit RAD and into the waiting room WR. The patient P1 is detected upon entering the waiting room WR as the tag 19 is sensed by the detector device 21 of the radiology unit waiting room WR. Though not shown, each patient P1 through P8 in the waiting room WR is accounted for as being present in that room, and the time of entry and dwell time are also tracked. Software is employed on a processing device, such as for example, a computer, to utilize data from a location engine source, which may be a software package to monitor ‘dwell time’ and create events based on variable thresholds. For example, the dwell time may be the time which a patient is present in the waiting room W zone. The event engine, which for example, may comprise software containing a set of instructions which may he executed when a threshold number of RFID devices (e.g., patients) are present in the radiology waiting room, W or when dwell time for one or more associated RFID patient tags is sensed at the waiting room W zone. The event engine may then utilize one or multiple communication paths for alerting people, such as hospital staff, or other management systems or engines, and even may record data for further analysis. The event engine may be configured with management responses that communicate instructions to hospital staff or a patient record when one or more events are sensed.

A detector 30 is provided at the entrance of the waiting room W, and a detector 31 is provided at the entrance/exit of the patient room PR. The detectors 30, 31 may include an exciter (or one may be separately provided). Each detector 30, 31 is uniquely identifiable to the network.

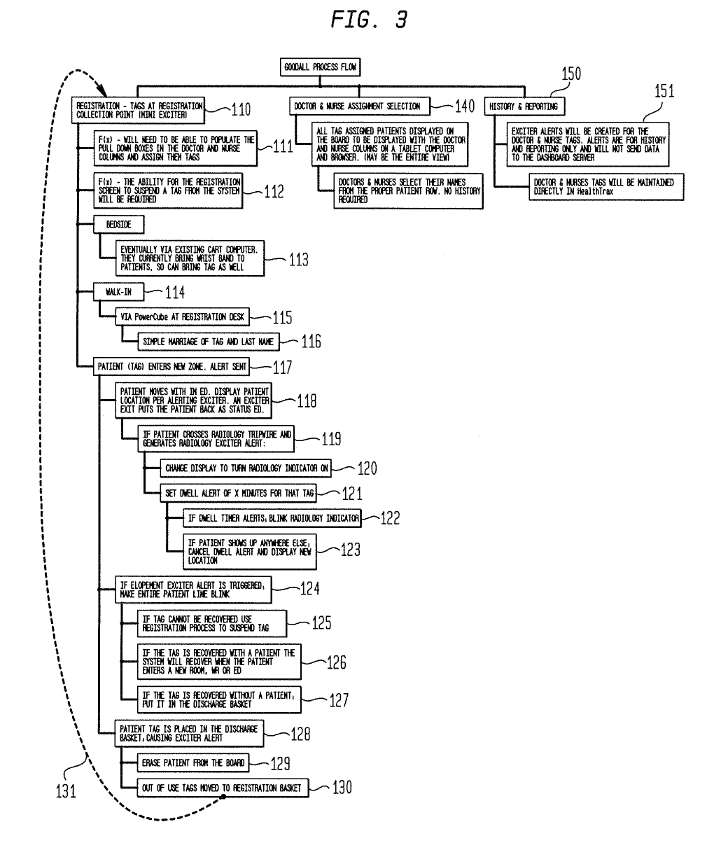

FIG. 3 is a flow diagram illustrating an embodiment of the method and apparatus showing an example of patient tracking and staff management features. In accordance with the illustration shown in FIG. 3, a patient is processed by a registration step 110 where a tag is assigned to a patient. According to the embodiment illustrated, one step 111 of the registration process may include assigning a doctor and nurse to a patient record and/or a patient tag. The doctor and nurse each may have his or her own tag which is uniquely identifiable. The registration also may include an option to suspend a tag 12 so that it is not active. The registration may also be accomplished with a portable computing unit such as, for example, using a portable cart 113. A wristband may be provided separately or with a tag and may be affixed to the patient's person at the location of registration. In addition to bedside registration (using a portable unit), walk-in registration 114 may be done at a registration desk 115 wherein a patient is provided with a tag and the tag is associated with a patient's name 116. As the patient enters a new zone, an alert is sent 117. As the patient moves within the care facility, patient locations may be displayed 118 for each alerting exciter encountered by that patient tag. For example, where a patient crosses a radiology trip wire 119, radiology exciter alert is generated and an indicator turned on 120. At the point of the exciter alert the dwell alert during x minutes (dwell time) is recorded 121 for that tag. A dwell threshold may provide a dwell timer alert and blink a radiology indicator on a display 122. If the patient is recorded at a location other than radiology the dwell alert initiated will be canceled and a new location displayed 123. A dwell alert will be set for the new location 123, if desirable, or if configured as a location within which to record dwell. As the patient enters a new zone another option is that the patient elopes from that zone without the process or treatment (i.e., a radiology procedure) having being administered. An elopement alert may be generated, for example by a blinking patient line on a display 124. If the patient is no longer in the facility, and the tag cannot be recovered, the registration process may be used to suspend the tag 125. Another option is where the tag is recovered with a patient 126 when the patient enters a new room, such as a waiting room (WR) or other location in the care facility, that patient record resumes recording. An exciter alert may also be generated 129 where the patient tag is placed in a discharge basket 127. Upon the discharge exciter alert the patient may be “erased” from the “white board”. In addition, the out of use tag may be moved to the registration basket 130 and the process renewed 131 with a next patient. In accordance with FIG. 3, there is also shown doctor and nurse assignment selection 140, as well as history and reporting 150. The history and reporting 150 may include generating alerts for history and reporting 151, including alerts which are not sent to the dashboard server, but which may be sent to one or more other devices. Doctors and nurse tags are maintained by the system 152 including with the SME and PME and PTE. A display, such as a board, may show patients assigned a tag, and the patients and their respective corresponding physicians and/or nurses may be shown on a display 141, including for example, a tablet or PDA. Doctors and nurses may select their names from a row to review patient assignment and information 142, which may involve a log on.

According to one embodiment, one or more antennae may be used to regulate the dimension of the zone of coverage for the detector (or group of detectors). For example, a tunable antenna may be employed to provide a geometrically configurable zone. For example, where zone is a generally linear zone of adjacent stations, such as, for example, where patient registration is occurring, the detector may be configured to cover the adjacent registration stations, and, at the same time, avoid detection into one or more adjacent areas or rooms which are not part of the patient registration area or zone. One embodiment may employ a unidirectional antenna. The antenna may have or be configured with a unidirectional radiation and response pattern, such as, for example a Yagi antenna.

An asset management engine (AME) may be provided and configured similar to the patient management engine (PME) and patient tracking engine (PTE), but tags are placed on hospital assets. The asset tag may have a unique identifier, and a general or group identifier distinguishing it from other tags (e.g., patient and staff). Assets may include, for example, equipment, such as wheel chairs, iv regulators, gurneys, as well as x-ray machines, MRI scanners, ultrasound machines, robotic surgical devices, and the like. Where an asset is mobile, the location tracking, similar to the patient location tracking, may be used to determine the location of the asset within the care facility. The AME may include software and may be configured with a set of instructions including, for example, a locating feature which may handle requests of a user to locate an asset. In addition, asset management data may also be collected and stored, including whether the asset is currently in use, or whether the asset is scheduled for use. Therefore, the user may locate an available asset, or determine whether an asset is available, or which asset is available. Availability may be determined by time of reservation or hierarchy of need (based on patient condition assessment which may be recoded as part of the patient data).

A staffing management engine (SME) may be provided, and like the PTE, PME and AME, may include software programmed with instructions for locating and tracking personnel, including nurses, physicians, attendants and other workers. According to some embodiments, the personnel of the care facility are assigned tags which may be separately provided or provided in the form of a badge or other element which is carried by the person. The locating apparatus and software may be configured to track the location of personnel, similar to the locating features described herein in connection with patients and/or assets. According to other embodiments, the staffing management engine (SME) may be operatively associated with one or more remote devices which may be carried by or on the person. The remote device may include communications means, and a display for displaying information. A remote device, such as, for example, a PDA, tablet, wearable or portable computing device, may include audible, visual or sensing means, such as a vibration mechanism, or combinations of them. Portable computing devices, such as, for example, those disclosed in U.S. Pat. No. 6,249,427 B1 issued on Jun. 19, 2001, U.S. Pat. No. 6,108,197 issued on Aug. 22, 2000, U.S. Pat. No. 6,097,607 issued on Aug. 1, 2000, U.S. Pat. No. 6,057,966 issued on May 2, 2000, U.S. Pat. No. 5,798,907 issued on Aug. 25, 1998, U.S. Pat. No. 5,581,492 issued on Dec. 3, 1996, U.S. Pat. No. 5,572,401 issued on Nov. 5, 1996, and U.S. Pat. No. 5,555,490 issued on Sep. 10, 1996, may be utilized in connection with the method and apparatus disclosed herein, though the invention is not limited to the use of these devices, and may use other computing devices, including other portable computing devices.

If personnel are needed at a location, such as for example, to discharge a patient from a patient room, a transport attendant may be located within the care facility. The SME may include a locating engine configured with locating software the SME be programmed to track whether the attendant is available or is currently assigned a task. The SME locating feature may be programmed to locate only available attendants. In addition, the attendant who is available may receive an alert, and may also receive one or more specific instructions, such as, report to patient room RM1 to discharge patient. The SME may be programmed to render the attendant unavailable upon issuance of the instruction so that subsequent calls for an attendant would identify this attendant as unavailable and hence would not select the same attendant for two simultaneous tasks. However, back to back scheduling may be permitted, for example, where only one attendant is available (e.g., due to a lunch break) so that the attendant may continue to receive instructions. This may be programmed to be a conditional function, such that during set periods of time, such as, for example, lunch time intervals (e.g., 11:00 to 2:00), an attendant may receive more than one instruction or task, and during other time intervals, tasks are assigned one at a time, upon completion of the prior task.

The SME also may be programmed to track dwell time, in the sense of the time it takes for an attendant to complete the discharge task. For example, if one particular attendant is taking five times as long for the same task as other attendants, not only will that attendant have longer time completions, but he/she will also have fewer tasks completed. The SME collects and stores information so that analytical evaluations may be performed, and reports generated. The SME may be used in connection with a reporting engine to generate reports of staffing activities and events from the staff data (which may be stored in a database). A management engine also may be provided to manage staff and/or tasks and assignments using the information from the SME.

An analysis and reporting engine (ARE) may be provided and may include software programmed to analyze the patient data, including location and dwell information, asset utilization data, and personnel data. The ARE is configured to utilize and access the data collected and stored by the PTE, PME, SME and AME, as well as other engines and/or modules which may be part of or used with the system. Patients may be analyzed according to one or more metrics, such as, for example, patient age, patient condition, patient healthcare provider, or the like, and reports generated. Efficiencies may also be determined using the data and analysis reports.

These and other advantages of the invention may be realized. Other advantages of the method and apparatus include, for example, the ability to track patient locations in real-time; notification of patients' unauthorized exits from the facility or a unit thereof; notification of patients who remain in one place longer than expected; tracking of assigned doctor and nurses to patients dynamically in real time; a dashboard of patients which may utilize a large flat panel displays such as LCD or plasma, for ease in viewing; automatic un-assignment of RFID tags from patients; a web based model allows ease of deployment and assists in bedside registration; integration with barcode scanning technologies to associate a patient to an RFID tag; the creation of customized reports, such as for example, door to door discharge time, and/or number of patients by provider; the ability to include user defined comment fields; and the ability to create custom zones.

While the invention has been described with reference to specific embodiments, the description is illustrative and is not to be construed as limiting the scope of the invention. Various modifications and changes may occur to those skilled in the art without departing from the spirit and scope of the invention described herein and as defined by the appended claims.

What is claimed is:

1. A method for facilitating managing patient care within a healthcare facility, including:
placing one or more signal detecting devices in a location within a healthcare facility, said range of said signal detecting device comprising a zone;
associating with a patient an RFID tag;
sensing the RFID tag as the patient moves within the range of a signal detecting device;
establishing one or more zones of detection within the healthcare facility;
providing data storage and collection means for collecting information;
collecting the information to determine the location of a patient in the care facility;
generating a display indicating the location of a patient within the care facility;
generating an alert when the patient location information corresponds with an event triggering threshold.
generating an alert when the number of RFID devices meets a threshold.

2. The method of claim 1, wherein the event triggering threshold is associated with a dwell time.

3. The method of claim 1, wherein the event triggering threshold is associated with the patient, entering an unauthorized zone.

4. The method of claim 1, wherein the event triggering threshold is associated with the patient, entering elopement from the facility.

5. The method of claim 1, wherein the event triggering threshold is associated with the patient, entering number of RFID tags detected as being present in one or more zones.

6. The method of claim 5, including determining whether the number of RFID devices detected within said particular zone meets a threshold.

7. The method of claim 1, wherein the zone is a location within a care facility.

8. The method of claim 1, wherein the dwell time for RFID devices corresponding to patients in a care facility location is determined, and wherein the alert is generated when the RFID devices associated with said patients dwell in said care facility location for a predetermined length of time.

9. A system for facilitating managing patient care within a healthcare facility from claim 1, including:
at least one signal detecting device adapted for positioning in a location within a care facility, said signal detecting device having a range corresponding to a zone;
an REID tag adapted to be carried on a one or more of a patient, hospital asset and personnel;
wherein said RFD tag carried by said on a one or more of a patient, hospital asset and personnel is configured to be detectible when said REID tag is within said zone corresponding to said signal detecting device;
data collection means for collecting the information to determine the number of RFID devices in a particular zone;
means for determining whether the number of RFID devices detected within said particular zone meets a threshold;
alert generating means for generating an alert when the number of RFID devices in said zone meets a threshold.

10. The system of claim 9, wherein a plurality of signal detecting devices are provided, and wherein a plurality of zones are configured, wherein each zone corresponds with one signal detecting device or a group of signal detecting devices.

11. The system of claim 9, including a patient management engine (PME).

12. The system of claim 9, including a staffing management engine (SME).

13. The system of claim 9, including an asset management system (AME).

14. The system of claim 4, including a PME, SME, and an AME.

15. An apparatus for facilitating managing patient care within a healthcare facility, including
at least one signal detecting device adapted for positioning in a location within a store, said signal detecting device having a range corresponding to a zone;
an RFID tag adapted to be carried on one or more of a patient, hospital asset and personnel;
wherein said RFID tag carried by said one or more of a patient, hospital asset and personnel is configured to be detectible when said RFID tag is in said zone corresponding to said signal detecting device;
a device for collecting data from said signal detecting device for collecting the information to determine the number of RFID devices in a particular zone;
an event engine for determining whether the number of RFID devices detected within said particular zone meets a threshold, said event engine being configured to generate an alert to correspond with detection criteria.

16. An apparatus for facilitating managing patient care within a healthcare facility, comprising:
at least one storage device;
at least one display, and
a processor connected to the storage device, the storage device storing a program for controlling the processor; and
the processor operative with the program to receive information inputs comprising signals relayed from at least one or more detection devices, and displaying on a display an indication of a location of one or more of a patient, an asset and a person providing services at the healthcare facility;
at least one detectable element provided on at least one or more of a patient, an asset, and a person providing services at the healthcare facility, wherein said at least one detectable element is uniquely identifiable from other said detectable elements;
at least one detection device for detecting said at least one detectable element;
said program being provided with instructions for associating a detection device with a location, and displaying on said display means information indicating the location of said patient, asset or person providing services at the healthcare facility.

17. The apparatus of claim 16, wherein a plurality of detection devices are arranged by location to define one or more detection zones.

18. The apparatus of claim 16, wherein a plurality of detection devices are arranged by location to define a plurality of detection zones.

19. The apparatus of claim 18, where said detection zones correspond with a unit, floor or area of a healthcare facility.

20. The apparatus of claim 16, wherein the detectible element comprises a tag.

21. The apparatus of claim 20, wherein the tag includes circuitry to ring at an assigned energy frequency.

22. The apparatus of claim 17, wherein an exciter is provided at each zone.

23. The apparatus of claim 22, wherein said exciter frequency uniquely corresponds with a zone.

24. The apparatus of claim 16, wherein each said detection device is uniquely identifiable and is arranged to correspond with a zone defining an area of a healthcare facility.

25. The apparatus of claim 16, wherein the processor is configured to perform the steps of:
identifying at least one or more of a patient, asset or personnel,
determining the location within the care facility of said at least one or more of a patient, asset or personnel,
displaying on a display the identification of said at least one or more of a patient, asset or personnel and its location within the care facility.

26. The apparatus of claim 25, wherein the processor is further configured to provide an alert when the location or time within a location triggers an event threshold.

27. The apparatus of claim 26, wherein said alert is provided on a display.

28. The apparatus of claim 27, wherein said alert is communicated to a responder.

29. The apparatus of claim 28, wherein said responder comprises one or more hospital personnel designated to address the condition that triggered the event threshold.

30. The apparatus of claim. 29, wherein said alert includes an instruction for responding to said event triggering threshold.
